(19) United States
(12) Patent Application Publication
(10) Pub. No.: US 2017/0288816 A1
(43) Pub. Date: Oct. 5, 2017

(54) METHOD AND SYSTEM FOR COMPENSATING HLS SLICE LOSS

(71) Applicants: LE HOLDINGS (BEIJING) CO., LTD., Beijing (CN); LECLOUD COMPUTING CO., LTD, Beijing (CN)

(72) Inventor: Bin LIU, Beijing (CN)

(21) Appl. No.: 15/246,243

(22) Filed: Aug. 24, 2016

Related U.S. Application Data
(63) Continuation of application No. PCT/CN2016/088882, filed on Jul. 6, 2016.

(30) Foreign Application Priority Data
Mar. 30, 2016 (CN) 201610192827.6

(51) Int. Cl. H04L 1/08; H04L 12/26

(52) U.S. Cl. CPC H04L 1/08; H04L 43/0847; H04L 67/02

(57) ABSTRACT

A method and a system are provided for compensating HLS slice loss. The method includes: configuring a compensation request agent on a lower server; transmitting by the lower server a subscription request to a plurality of upper servers corresponding thereto, and obtaining by the lower server slices issued by message issuing pools of the plurality of upper servers according to the subscription request; performing a slice loss detection by the lower server for the slice information received, and generating by the lower server a slice loss request when it is detected that a slice loss occurs; transmitting by the compensation request agent the generated slice loss request to the plurality of upper servers.

### CROSS REFERENCE TO RELATED APPLICATIONS

This application is a continuation of International Application No. PCT/CN2016/088882, filed on Jul. 6, 2016, which is based upon and claims priority to Chinese Patent Application No. 201610192827.6, filed on Mar. 30, 2016, the entire contents of which are incorporated herein by reference.

### TECHNICAL FIELD

The embodiments of the present disclosure relate to the technical field of live video broadcasting, and in particular to a method and system for compensating HLS slice loss.

### BACKGROUD

HLS (HTTP Live broadcasting) is a protocol defined by Apple Inc. for real-time streaming transport, which is realized based on the HTTP protocol, and the transmission contents comprise two parts, namely, m3u8 description files and TS media files. At present, in the industry, the HLS live broadcasting scheme is generally realized via the Internet TCP protocol. However, due to uncertainties of network conditions, connection jitters sometimes occur between the internal nodes of relay distribution networks, resulting in pauses and frame losses during playing by the user, which greatly influences the user experience.

During the implementation process of the present disclosure, the inventor finds that the prior art at least has the following problem: in the framework of the prior art, communications between the upper and lower layers are based on one-way notification; therefore, even if the lower layer knows which specific slice is lost, it cannot notify the upper servers at higher layers of the lost slice, and thus cannot obtain the compensated slice in time.

### SUMMARY

In a first aspect, the present disclosure provides a method for compensating HLS slice loss. The method may include: configuring a compensation request agent on a lower server; transmitting by the lower server a subscription request to a plurality of upper servers corresponding thereto, and obtaining by the lower server slices issued by message issuing pools of the plurality of upper servers according to the subscription request; performing a slice loss detection by the lower server for the slice information received, and generating by the lower server a slice loss request when it is detected that a slice loss occurs; and transmitting by the compensation request agent the generated slice loss request to the plurality of upper servers.

In a second aspect, the present disclosure provides a system for compensating HLS slice loss. The system may include: lower servers each corresponding to a plurality of upper servers, the upper servers issuing slices by message issuing pools, the lower server including a slice obtaining module configured to transmit a subscription request to the plurality of upper servers and obtain slices issued by the message issuing pools of the plurality of upper servers, wherein, the lower server is also provided with a compensation request agent and a slice loss detecting module. The slice loss detecting module is configured to perform a slice loss detection for the slice information received, and generate a slice loss request when it is detected that a slice loss occurs. The compensation request agent is configured to transmit the generated slice loss request to the plurality of upper servers.

In a third aspect, the present disclosure provides a non-transitory computer-readable storage medium storing executable instructions. When executed by one or more processors, the instructions cause the one or more processors to: transmit a subscription request to the plurality of upper servers and obtain slices issued by the message issuing pools of the plurality of upper servers; perform a slice loss detection for slice information received, and generate a slice loss request when it is detected that a slice loss occurs; and transmit the generated slice loss request to the plurality of upper servers.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a structural diagram of the system framework of the live broadcasting scheme in the prior art;

FIG. 2 is a schematic structural view of an embodiment of a system for compensating HLS slice loss of the present disclosure;

FIG. 3 is a flow chart of an embodiment of a method for compensating HLS slice loss of the present disclosure;

FIG. 4 is a schematic structural view of a device 400 that implements the method for compensating HLS slice loss of the embodiments of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

The embodiments of the present disclosure provides a method and a system for compensating HLS slice loss in order to solve the problem that slice loss is likely to occur in the traditional HLS live broadcasting scheme and it is not possible to obtain the compensated slice in time when the slice loss occurs, thereby realizing real-time compensation for slice loss, and improving the terminal playing experience. By configuring a compensation request agent on the lower server, the method and system for compensating HLS slice loss provided by the embodiments of the present disclosure can transmit a slice loss request to the upper servers in time when it is detected that a slice loss occurs, so as to obtain a compensation in time and reduce the pausing phenomenon, thereby improving the terminal playing experience.

The followings will provide more detailed descriptions of the embodiments of the present disclosure with reference to the drawings.

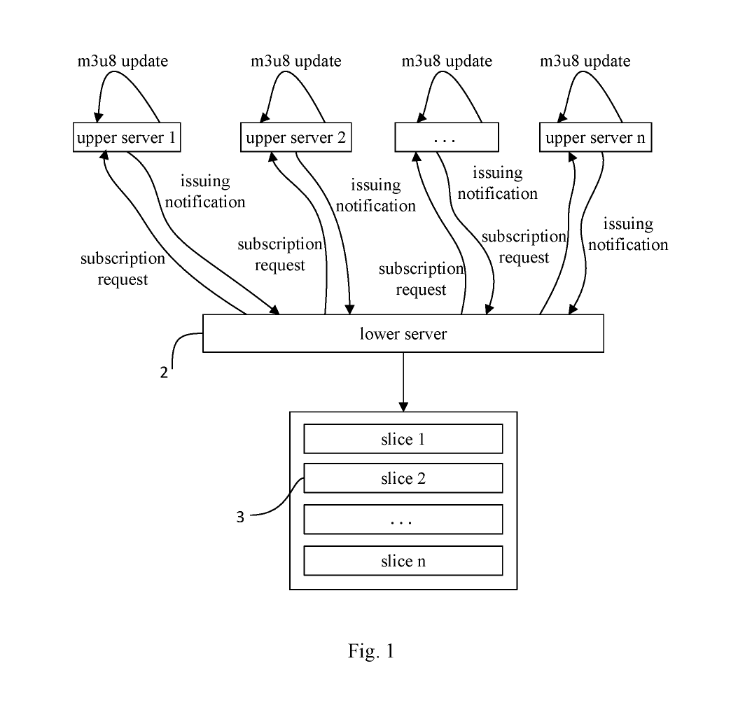

FIG. 1 schematically shows the structure of the system framework of the live broadcasting scheme in the prior art. As shown in FIG. 1, each lower server 2 in the framework corresponds to a plurality of upper servers 1. The lower server 2 transmits a subscription request to the upper servers 1. When m3u8 files are updated, the upper servers 1 issue the new m3u8 files and transmit issuing notifications to the corresponding lower server 2, and then the lower server 2 obtains the corresponding slice 3 according to the message issuing of the upper servers 1 corresponding thereto. It can be seen from the framework that, in the prior art, each lower server 2 only transmits a subscription request to its corresponding upper servers 1 for once when it makes a request for the first time, and thereafter it just waits passively for the notifications to update the slice 3. In this mode, once a jitter occurs to the network, a slice loss is likely to occur. In addition, since the communications between the lower server 2 and its corresponding upper servers 1 are based on one-way notification, i.e., after transmitting the subscription request, the lower server 2 passively waits for the upper servers 1 to issue notifications; Therefore, when a slice loss occurs, even if the lower server knows which specific slice is lost, it cannot notify the corresponding upper servers of information of the lost slice, let alone obtain the compensation in time, and this will bring very bad playing experience for the terminals.

So, the present disclosure provides a system and a method for compensating HLS slice loss to solve the deficiencies in the traditional live broadcasting framework and method.

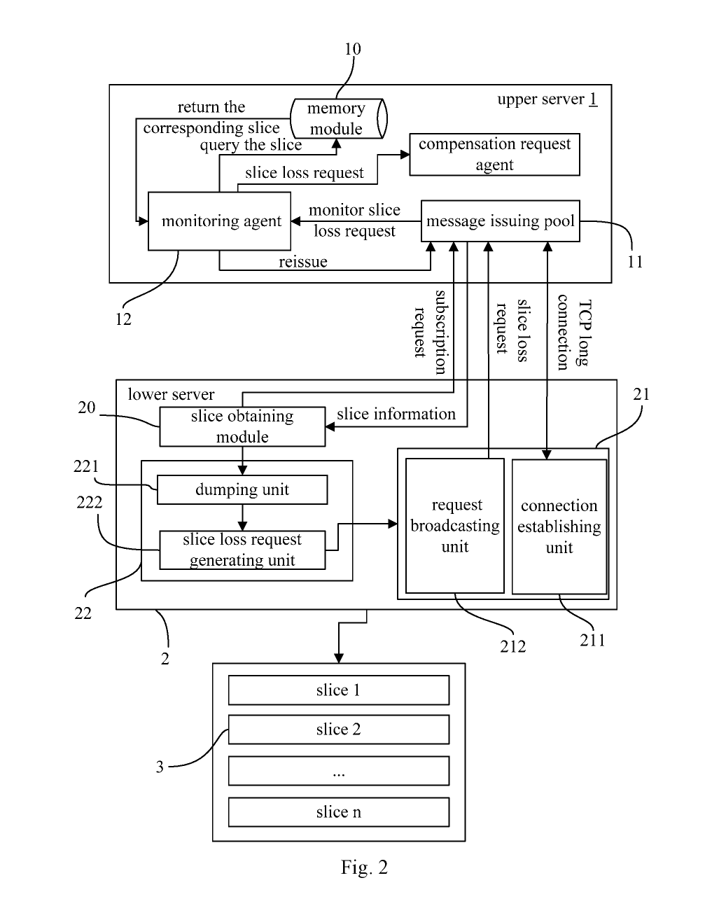

FIG. 2 schematically shows the frame structure of the system for compensating HLS slice loss of the embodiments of the present disclosure. As shown in FIG. 2, the system includes a lower server 2 and an upper server 1, the upper server 1 has a message issuing pool 11 for issuing slice information obtained from servers of higher layers. The lower server 2 includes a slice obtaining module 20. The lower server 2 transmits a subscription request to the corresponding plurality of upper servers 1 by the slice obtaining module 20, and receives a message notification from the upper server, and thereby obtains the slices issued by the message issuing pool 11 of the plurality of upper servers 1 according to the subscription request. Each lower server 2 corresponds to a plurality of upper servers 1, so that the probability of slice loss is reduced.

As shown in FIG. 2, the embodiments of the present application configure a compensation request agent 21 and a slice loss detecting module 22 on the lower server 2. The slice loss detecting module 22 is configured to perform a slice loss detection for the received slice information issued by the plurality of upper servers, and generate a slice loss request when it is detected that a slice loss occurs; the compensation request agent 21 is configured to transmit the generated slice loss request to the plurality of upper servers 1 so as to obtain a slice loss compensation. By adding the slice loss detecting module 22 and the compensation request agent 21 on the lower server 2, the system of the embodiments of the present disclosure can detect the slice loss situation in time, and transmit the slice loss request to the upper server when it is detected that the slice loss occurs, which realizes a full duplex communication between the upper servers and the lower server, thereby satisfying the requirement of real-time compensation.

In this embodiment, the lower server is a server or a server cluster, wherein each module may be an individual server or server cluster; at this time, an interaction between the above modules manifest as an interaction between the server or server cluster corresponding to said each module, and the plurality of servers or server clusters jointly form the system for compensating HLS slice loss of this disclosure.

In particular, the system for compensating HLS slice loss of the present disclosure formed by the plurality of servers or server clusters together includes:

a slice obtaining server or server cluster configured to transmit a subscription request to the corresponding plurality of upper servers 1, receive message notifications from the upper servers, and obtain slices issued by the message issuing pools of the plurality of upper servers according to the subscription request;

a slice detecting server or server cluster configured to perform a slice loss detection for the received slice information issued by the plurality of upper servers, and generate a slice loss request when it is detected that a slice loss occurs;

a compensation request agent server or server cluster configured to transmit the generated slice loss request to the plurality of upper servers so as to obtain a slice loss compensation.

In an alternative embodiment, several modules of the above mentioned plurality of modules may jointly form a server or server cluster. For example: the slice obtaining module constitutes a first server or a first sever cluster, and the slice detecting module and the compensation request agent jointly form a second server or a second server cluster.

At this time, the interaction between the above modules manifests as an interaction between the first server and each second server or an interaction between the first server cluster and the second server clusters, and the first and second servers or the first and second server clusters jointly form the system for compensating HLS slice loss of the present disclosure.

As shown in FIG. 2, the slice loss detecting module 22 includes a dumping unit 221 and a slice loss request generating unit 222. The dumping unit 221 is used for storing slice information locally according to a name of an obtained slice. The slice loss request generating unit 222 is used for matching a serial number of the slice with the serial numbers of the stored slices, and when the matching result is that the serial numbers are discontinuous, generating a slice loss request and transmitting the slice loss request to the compensation request agent 21. The slice loss request includes the serial number of the lost slice detected. In the system of the embodiments of the present disclosure, the slices will be numbered with each slice corresponds to a unique serial number. The serial numbers are continuous, for example, the serial number of the first slice is 1, the serial number of the second slice is 2, . . . , the serial number of the Nth slice is N. After the lower server 2 receives the slices, firstly, the slices are stored by the dumping unit 221 in a local memory module (such as a database), and then the serial numbers of the slices are detected by the slice loss request generating unit 222. To be specific, the serial number of a received slice is compared with the serial numbers of the received slices stored in the database. If the serial numbers are not continuous, for example, the currently received serial number is 5, but the closest serial number stored in the memory is 3, this indicates that the slice whose serial number is 4 is lost. At this time, a slice loss request will be generated according to the serial number of the slice, which includes the serial number corresponding to the lost slice. After the slice loss request is generated, the slice loss request generating unit 222 will transmit the slice loss request to the compensation request agent 21. The compensation request agent 21 includes a connection establishing unit 211 and a request broadcasting unit 212. The connection establishing unit 211 will establish a TCP persistent connection between the compensation request agent 21 and the message issuing pools of the plurality of upper servers corresponding to the lower server. After the compensation request agent 21 receives the slice loss request, the request broadcasting unit 212 will broadcast the slice loss request to the message issuing pools of the corresponding plurality of upper servers via the TCP connection. Thus, when the slice loss occurs, the lower server can broadcast it to all the upper servers, thereby realizing the full duplex communication between the lower server and the upper servers.

In this embodiment, the slice loss detecting module may be a server or a server cluster, wherein each of the above units may be an individual server or server cluster, and at this time, the interaction between the above units manifests as an interaction between the servers corresponding to each of the units.

In an alternative embodiment, one or two of the dumping unit and the slice loss request generating unit may jointly form a server or server cluster.

In this embodiment, the compensation request agent may be a server or a server cluster, wherein each of the above units may be an individual server or server cluster, at this time, the interaction between the above units manifests as the interaction between the servers corresponding to each of the units.

In an alternative embodiment, one or two of the connection establishing unit and the request broadcasting unit may jointly form a server or server cluster.

As shown in FIG. 2, the upper server 1 also includes a memory module 10 and a monitoring agent 12. The memory module 10 is configured to store the slice information according to the serial numbers, and a redis database (an open source key-value high performance no-sql database, i.e., a high performance no-sql database based on key-value) may be employed. The monitoring agent 12 is configured to monitor the slice loss request of the lower server, and perform a slice loss compensation for the lower server according to the slice loss request. In specific applications, the monitoring agent 12 continuously monitors whether the message issuing pool 11 of the present machine has received the slice loss request transmitted from the lower server 2; and when it monitors that the message issuing pool 11 of the present machine has received the slice loss request, it searches for the corresponding slice in the memory module 10 of the present machine according to the serial number in the slice loss request. When the corresponding slice is queried (i.e., there exists a slice item in the memory module that matches with the serial number), the monitoring agent 12 will issue the corresponding slice information to the message issuing pool 11 of the present machine to be reissued by the message issuing pool of the present machine. When the corresponding slice is not queried, this means that the slice loss phenomenon also occurs when the present machine obtains slices from servers of higher layers, at this time, the present machine will serve as a lower server and perform a slice loss request to its upper servers. Therefore, the monitoring agent 12 will transmit the slice loss request to the compensation request agent of the present machine, so as to perform the slice loss request to the upper servers corresponding to the present machine. As such, a real-time slice loss compensation for the lower server can be realized, which reduces the probability of slice loss and improves the live broadcasting experience of the terminals.

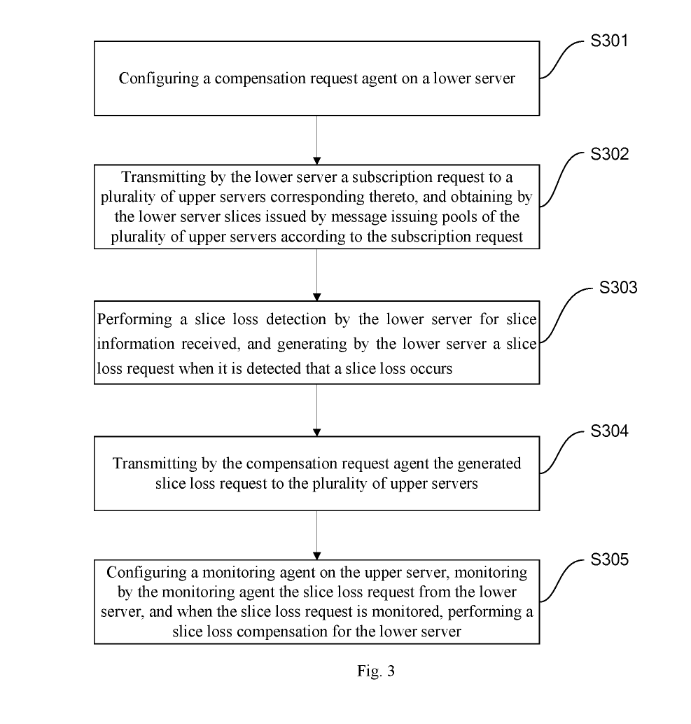

FIG. 3 schematically shows the flow of the method for compensating HLS slice loss of the embodiments of the present disclosure. As shown in FIG. 3, the method includes the following steps S301-S305.

Step S301 includes configuring a compensation request agent on a lower server.

The compensation request agent is configured on the lower server for establishing a TCP persistent connection with the message issuing pools of the upper servers, and when the slice loss occurs, broadcasting the slice loss request to the message issuing pools of all upper servers corresponding to the present machine.

Step S302 includes transmitting by the lower server a subscription request to a plurality of upper servers corresponding thereto, and obtaining by the lower server slices issued by message issuing pools of the plurality of upper servers according to the subscription request.

The lower server transmits the subscription request to the plurality of upper servers corresponding thereto according to the needs, and the message issuing pools of the upper servers will issue the slices to the corresponding subjects according to the received subscription request and transmit the issuing notifications to their lower servers. The lower server receives the issuing notifications from the upper servers, and obtains the slices according to the messages issued by the message issuing pools of the upper servers.

Step S303 includes performing a slice loss detection by the lower server according to the slice information received, and generating by the lower server a slice loss request when it is detected that a slice loss occurs.

After obtaining the slices, the lower server stores the slices in the local database according to the names of the slices, and at the same time, a slice loss detection will be performed for the received slices. To be specific, the serial number of a received slice will be compared with the serial numbers of the slices stored in the database; and when the serial numbers of the newly received slice is not continuous with a serial number of the slice stored in the database which is closest to this serial number, this means that a slice loss occurs, and thus a slice loss request will be generated. The slice loss request includes the serial number of the lost slice.

Step S304 includes transmitting by the compensation request agent the generated slice loss request to the plurality of upper servers.

The compensation request agent broadcasts the generated slice loss request to all upper servers corresponding thereto via the established TCP persistent connection, and the upper servers receive the slice loss request from the lower server by their message issuing pools according to the established TCP persistent connection.

Step S305 includes configuring a monitoring agent on the upper servers, monitoring by the monitoring agent the slice loss request of the lower server, and when the slice loss request is monitored, performing a slice loss compensation for the lower server.

A monitoring agent is configured on the upper servers. The monitoring agent will monitor the message issuing pool of the present machine, and when the message issuing pool of the present machine receives a slice loss request, will obtain the corresponding slice in the database of the present machine according to the serial number of the lost slice in the slice loss request. If there exists the corresponding slice in the database of the present machine, the slice will be transmitted to the message issuing pool to be reissued, and if there does not exist the corresponding slice, this means that the slice loss of the slice also occurs in the present machine; and at this time, the present machine will serve as a lower server and perform a compensation request to its upper servers via the compensation request agent.

The system and method of the embodiments of the present disclosure can realize the full-duplex communication between the lower server and the upper servers by the compensation request agent configured on the lower server, and the full-duplex communication of the persistent connection can reduce the number of times of requests from the lower server, so as to reduce the pressures of the upper servers and the core production device. Thus, the reliance of the lower server on the core production device can be reduced, which realizes the real-time compensation for slice loss and decreases the slice loss frequency when interruptions occur in the intermediate network status, thereby improving the playing experience of device terminals.

Hardware processor can be used to implement relevant function module of embodiments of the present disclosure.

The present disclosure provides a non-transitory computer readable storage medium which stores one or more programs including execution instructions, and the execution instructions are executable by electronic devices that have control interfaces for execution of the related steps in the above method embodiments, for example:

configuring a compensation request agent on a lower server;

transmitting by the lower server a subscription request to a plurality of upper servers corresponding thereto, and obtaining by the lower server slices issued by message issuing pools of the plurality of upper servers according to the subscription request;

performing a slice loss detection by the lower server for the slice information received, and generating by the lower server a slice loss request when it is detected that a slice loss occurs; and

transmitting by the compensation request agent the generated slice loss request to the plurality of upper servers.

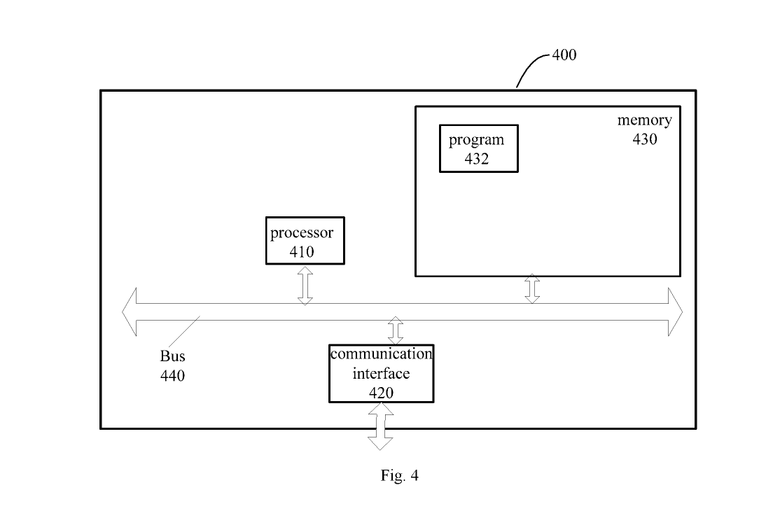

FIG. 4 is a structural diagram of the device 400 of the method for compensating HLS slice loss of the embodiments of the present disclosure, and the specific embodiment of the present disclosure will not define the specific implementation manners of the device 400. As shown in FIG. 4, the device 400 may includes:

a processor 410, a communications interface 420, a memory 430 and a communication bus 440.

Communications among the processor 410, the communications interface 420 and the memory 430 are accomplished via the communication bus 440.

The communications interface 420 is configured to communicate with a network element, such as a client.

The processor 410 is configured to execute a program 432 in the memory 430, so as to execute the related steps in the above method embodiments.

In particular, the program 432 may include a program code which includes a computer operation instruction.

The processor 410 may be a Central Processing Unit (CPU), or an Application Specific Integrated Circuit (ASIC), or one or more integrated circuits configured to implement the embodiments of the present disclosure.

The memory 430 is configured to store the program 432. The memory 430 may include a high speed RAM memory, and may also include a non-volatile memory, such as at least one disk memory. The program 432 may in particular be configured to cause the device 400 to execute the following operations:

a configuring step: configuring a compensation request agent;

a slice obtaining step: transmitting a subscription request to the corresponding plurality of upper servers, and obtaining slices issued by the message issuing pools of the plurality of upper servers according to the subscription request;

a slice loss detecting step: performing a slice loss detection for the slice information received, and generating a slice loss request when it is detected that a slice loss occurs; and

a compensation requesting step: transmitting the generated slice loss request to the plurality of upper servers.

The specific realization manners of each step in the program 432 can be seen from the corresponding descriptions of the corresponding steps and units in the above embodiments, and will not be described further herein. It can be well appreciated for the skilled person in the art that specific operation procedure of the devices and modules described above can be referred to the corresponding description of the procedure in the above embodiments of the method according to the disclosure, and thus are omitted for the sake of conciseness.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A method for compensating HTTP Live broadcasting (HLS) slice loss, comprising:
configuring a compensation request agent on a lower server;
transmitting a subscription request to a plurality of upper servers corresponding thereto by the lower server, and obtaining slices issued by message issuing pools of the plurality of upper servers according to the subscription request by the lower server;
performing a slice loss detection for slice information received by the lower server, and generating by the lower server a slice loss request when it is detected that a slice loss occurs; and
transmitting the generated slice loss request to the plurality of upper servers by the compensation request agent.

2. The method according to claim 1, wherein performing a slice loss detection for slice information received by the lower server, and generating by the lower server a slice loss request when it is detected that a slice loss occurs comprises:
storing the slices locally according to names of the slices obtained by the lower server; and
matching r a serial number of the slice with serial numbers of the stored slices by the lower serve, and when determining that the serial numbers are discontinuous, generating a slice loss request which comprises a serial number of a detected lost slice by the lower server.

3. The method according to claim 1, wherein transmitting the generated slice loss request to the plurality of upper servers by the compensation request agent comprises:
establishing a Transmission Control Protocol (TCP) persistent connection between the message issuing pools of the plurality of upper servers corresponding to the lower server and the compensation request agent;
broadcasting by the compensation request agent the slice loss request to the message issuing pools of the corresponding plurality of upper servers via the TCP persistent connection.

4. The method according to claim 1, further comprising:
configuring a monitoring agent on the upper server, monitoring by the monitoring agent the slice loss request from the lower server, and when the slice loss request is monitored, performing a slice loss compensation for the lower server.

5. The method according to claim 4, wherein, configuring a monitoring agent on the upper server, monitoring by the monitoring agent the slice loss request of the lower server, and when the slice loss request is monitored, performing a slice loss compensation for the lower server comprises:
monitoring by the monitoring agents of the plurality of upper servers whether the message issuing pool of a present machine has received the slice loss request transmitted from the lower server, and when it is monitored that the message issuing pool of the present machine has received the slice loss request, searching for a corresponding slice in a memory storage of the present machine according to the slice loss information; ,
issuing the slice information to the message issuing pool of the present machine when the corresponding slice is queried according to the searching result;
when the corresponding slice is not queried according to the searching result, performing the slice loss request to one or more upper servers corresponding to the present machine.

6. An electronic device for compensating HTTP Live broadcasting (HLS) slice loss, comprising: at least one processor; and a memory communicably connected with the at least one processor for storing instructions executable by the at least one processor, wherein execution of the instructions by the at least one processor causes the at least one processor to:
transmit a subscription request to a plurality of upper servers and obtain slices issued by the message issuing pools of the plurality of upper servers;
perform a slice loss detection for slice information received, and generate a slice loss request when it is detected that a slice loss occurs; and
transmit the generated slice loss request to the plurality of upper servers.

7. The electronic device according to claim 6, wherein the at least one processor is further configured to:
store the slice locally by the lower server according to a name of the obtained slice; and
match a serial number of the slice with serial numbers of the stored slices, and when determining that the serial numbers are discontinuous, generate a slice loss request which comprises a serial number of a detected lost slice.

8. The electronic device according to claim 6, wherein the at least one processor is further configured to:
establish a Transmission Control Protocol (TCP) persistent connection between the message issuing pools of the plurality of upper servers corresponding to the lower server and the compensation request agent; and
broadcast the slice loss request to the message issuing pools of the corresponding plurality of upper servers via the TCP persistent connection.

9. The electronic device according to claim 6, wherein the upper server is configured to monitor the slice loss request of the lower server, and perform a slice loss compensation for the lower server according to the received slice loss request.

10. The electronic device according to claim 9, wherein the upper server is further configured to:
monitor whether the message issuing pool of a present machine has received the slice loss request transmitted from the lower server, and
when it is monitored that the message issuing pool of the present machine has received the slice loss request, search for a corresponding slice in a memory storage of the present machine according to the slice loss information.

11. The electronic device according to claim 10, wherein the upper server is further configured to:
when the corresponding slice is queried according to the searching result, issue the slice information to the message issuing pool of the present machine; and
when the corresponding slice is not queried according to the searching result, perform the slice loss request to one or more upper servers corresponding to the present machine.

12. A non-transitory computer-readable storage medium storing executable instructions that, when executed by one or more processors, cause the one or more processors to:
transmit a subscription request to a plurality of upper servers and obtain slices issued by message issuing pools of a plurality of upper servers;
perform a slice loss detection for slice information received, and generate a slice loss request when it is detected that a slice loss occurs; and
transmit the generated slice loss request to the plurality of upper servers.

13. The non-transitory computer-readable storage medium according to claim 12, wherein the executable instructions further cause the one or more processors to:
store the slice locally by the lower server according to a name of the obtained slice; and
match a serial number of the slice with serial numbers of the stored slices, and when determining that the serial numbers are discontinuous, generate a slice loss request which comprises a serial number of a detected lost slice.

14. The non-transitory computer-readable storage medium according to claim 12, wherein the executable instructions further cause the one or more processors to:
establish a Transmission Control Protocol (TCP) persistent connection between the message issuing pools of the plurality of upper servers corresponding to the lower server and a compensation request agent; and
broadcast the slice loss request to the message issuing pools of the corresponding plurality of upper servers via the TCP persistent connection.

15. The non-transitory computer-readable storage medium according to claim 12, wherein the executable instructions further cause the one or more processors to:
monitor the slice loss request of the lower server, and perform a slice loss compensation for the lower server according to the received slice loss request.

16. The non-transitory computer-readable storage medium according to claim 15, wherein the executable instructions further cause the one or more processors to:
monitor whether the message issuing pool of a present machine has received the slice loss request transmitted from the lower server, and
when it is monitored that the message issuing pool of the present machine has received the slice loss request, search for a corresponding slice in a memory storage of the present machine according to the slice loss information.

17. The non-transitory computer-readable storage medium according to claim 16, wherein the executable instructions further cause the one or more processors to:
when the corresponding slice is queried according to the searching result, issue the slice information to the message issuing pool of the present machine; and
when the corresponding slice is not queried according to the searching result, perform the slice loss request to one or more upper servers corresponding to the present machine.
